(19) United States
(12) Patent Application Publication
(10) Pub. No.: US 2021/0109390 A1
(43) Pub. Date: Apr. 15, 2021

(54) POLARIZING FILM WITH ADDED ADHESIVE LAYER, POLARIZING FILM WITH ADDED ADHESIVE LAYER FOR IN-CELL LIQUID CRYSTAL PANEL, IN-CELL LIQUID CRYSTAL PANEL, AND LIQUID CRYSTAL DISPLAY DEVICE

(71) Applicant: NITTO DENKO CORPORATION, Ibaraki-shi, Osaka (JP)

(72) Inventors: Masakuni Fujita, Ibaraki-shi (JP); Yusuke Toyama, Ibaraki-shi (JP)

(73) Assignee: NITTO DENKO CORPORATION, Ibaraki-shi, Osaka (JP)

(21) Appl. No.: 16/498,567

(22) PCT Filed: Mar. 28, 2018
(86) PCT No.: PCT/JP2018/012628

§ 371 Date: Sep. 27, 2019

(30) Foreign Application Priority Data
Mar. 28, 2017 (JP) 2017-063991

(51) Int. Cl. G02F 1/1333; C09J 7/38; G02F 1/1339; G02F 1/1335

(52) U.S. Cl. CPC G02F 1/13338; C09J 7/385; C09J 2203/318; G02F 1/133528; G02F 1/1339

(57) ABSTRACT

A pressure-sensitive adhesive layer attached polarizing film is provided with a pressure-sensitive adhesive layer and a polarizing film, wherein the pressure-sensitive adhesive layer is formed from a pressure-sensitive adhesive composition comprising an inorganic cation-anion salt and a (meth)acrylic polymer containing, as monomer units, an alkyl (meth)acrylate and a polar functional group-containing monomer; and a ratio (b/a) of a variation in a surface resistance value on a side of the pressure-sensitive adhesive layer before and after humidification is 5 or less.

### TECHNICAL FIELD

The present invention relates to a pressure-sensitive adhesive layer attached polarizing film; a pressure-sensitive adhesive layer attached polarizing film for an in-cell type liquid crystal panel; an in-cell type liquid crystal cell having a touch sensing function incorporated inside the liquid crystal cell; and an in-cell type liquid crystal panel comprising a pressure-sensitive adhesive layer attached polarizing film on the viewing side of the in-cell type liquid crystal cell. Furthermore, the present invention relates to a liquid crystal display device using the liquid crystal panel. The liquid crystal display device provided with a touch sensing function using the in-cell type liquid crystal panel of the present invention can be used as various input display devices such as mobile apparatuses.

### BACKGROUND ART

Generally, in liquid crystal display devices, polarizing films are bonded to both sides of a liquid crystal cell with a pressure-sensitive adhesive layer interposed therebetween from the viewpoint of image forming system. In addition, ones that mount a touch panel on a display screen of a liquid crystal display device have been put to practical use. As the touch panel, there are various methods such as an electrostatic capacitance type, a resistive film type, an optical type, an ultrasonic type, an electromagnetic induction type and the like, but an electrostatic capacitance type has been increasingly adopted. In recent years, a liquid crystal display device provided with a touch sensing function that incorporates an electrostatic capacitance sensor as a touch sensor unit has been used.

On the one hand, at the time of manufacturing a liquid crystal display device, when bonding the pressure-sensitive adhesive layer attached polarizing film to a liquid crystal cell, a release film is peeled from the pressure-sensitive adhesive layer of the pressure-sensitive adhesive layer attached polarizing film, and static electricity is generated by such peeling. Static electricity is also generated when a surface protective film of the polarizing film stuck to the liquid crystal cell is peeled off or when a surface protective film of the cover window is peeled off. The static electricity generated in this way affects the alignment of the liquid crystal layer inside the liquid crystal display device and causes defects. Generation of static electricity can be suppressed, for example, by forming an antistatic layer on the outer surface of the polarizing film.

On the other hand, the electrostatic capacitance sensor in the liquid crystal display device provided with a touch sensing function detects a weak electrostatic capacitance formed by a transparent electrode pattern and the finger when the user's finger approaches the surface. In the case where a conductive layer such as an antistatic layer is provided between the transparent electrode pattern and the user's finger, the electric field between a driving electrode and a sensor electrode is disturbed, the sensor electrode capacitance becomes unstable and the touch panel sensitivity decreases, causing malfunction. In a liquid crystal display device provided with a touch sensing function, it is required to suppress the occurrence of static electricity and suppress the malfunction of the capacitance sensor. For example, in order to reduce the occurrence of display defects and malfunctions in a liquid crystal display device provided with a touch sensing function for the purpose of solving the above-mentioned problems, it has been proposed to dispose a polarizing film comprising an antistatic layer with a surface resistance value of from 1.0×10⁹ to 1.0×10¹¹Ω/□ on the viewing side of the liquid crystal layer (Patent Document 1).

### PRIOR ART DOCUMENT

### Patent Document

Patent Document 1: JP-A-2013-105154

### SUMMARY OF THE INVENTION

### Problems to be Solved by the Invention

According to the polarizing film comprising an antistatic layer described in Patent Document 1, generation of static electricity can be suppressed to some extent. However, in Patent Document 1, since the location of the antistatic layer is farther than the position of the liquid crystal cell causing display failure due to static electricity, this case is not effective as compared with the case where the pressure-sensitive adhesive layer is provided with the antistatic function. Further, it has been found that the in-cell type liquid crystal cell is more easily charged than a so-called on-cell liquid crystal cell comprising a sensor electrode on a transparent substrate of the liquid crystal cell described in Patent Document 1. In addition, in a liquid crystal display device provided with a touch sensing function using an in-cell type liquid crystal cell, it was found that conduction from the side can be imparted by providing a conduction structure on the side surface of the polarizing film, but when the antistatic layer is thin, the contact area with the conduction structure on the side surface is small, so that sufficient conductivity cannot be obtained, causing conduction failure. On the other hand, it was found that the touch sensor sensitivity decreases as the antistatic layer becomes thicker.

On the other hand, the pressure-sensitive adhesive layer to which an antistatic function is imparted is effective for suppressing generation of static electricity and preventing static electricity unevenness more than the antistatic layer provided on the polarizing film. However, it was found that when the conductive function of the pressure-sensitive adhesive layer is enhanced with importance placed on the antistatic function of the pressure-sensitive adhesive layer, the touch sensor sensitivity is lowered. In particular, it was found that the touch sensor sensitivity is lowered in the liquid crystal display device provided with the touch sensing function using the in-cell type liquid crystal cell. Further, it was found that the antistatic agent blended in the pressure-sensitive adhesive layer for enhancing the conductivity function segregates at the interface with the polarizing film in a humidified environment (after a humidification reliability test) and moves into the polarizing film or to the interface on the viewing side of the liquid crystal cell, so that adhesiveness or durability is not sufficiently obtained or an increased surface resistance value on a side of the pressure-sensitive adhesive layer significantly reduces the antistatic function. It was also found that such a variation in the surface resistance value on a side of the pressure-sensitive adhesive layer is a cause of generation of electrostatic unevenness as well as occurrence of malfunctions of a liquid crystal display device provided with a touch sensing function.

Therefore, an object of the present invention is to provide a pressure-sensitive adhesive layer attached polarizing film, an in-cell type liquid crystal cell and a pressure-sensitive adhesive layer attached polarizing film for an in-cell type liquid crystal panel applied to the viewing side thereof, and an in-cell type liquid crystal panel comprising the pressure-sensitive adhesive layer attached polarizing film, which is excellent in adhesiveness (anchoring force) between the polarizing film and the pressure-sensitive adhesive layer and is capable of preventing clouding attributable to the pressure-sensitive adhesive layer even in a humidified environment, as well as satisfying a stable antistatic function and touch sensor sensitivity and is excellent in humidification durability. Another object of the present invention is to provide a liquid crystal display device using the in-cell type liquid crystal panel.

### Means for Solving the Problems

As a result of intensive studies to solve the above problems, the present inventors have found that the above problems can be solved by the following pressure sensitive adhesive layer attached polarizing film, pressure sensitive adhesive layer attached polarizing film for an in-cell type liquid crystal panel, and in-cell type liquid crystal panel, and have completed the present invention.

That is, the pressure-sensitive adhesive layer attached polarizing film of the present invention is a pressure-sensitive adhesive layer attached polarizing film which comprises a pressure-sensitive adhesive layer and a polarizing film, wherein:

the pressure-sensitive adhesive layer is formed from a pressure-sensitive adhesive composition comprising an inorganic cation-anion salt and a (meth)acrylic polymer containing, as monomer units, an alkyl (meth)acrylate and a polar functional group-containing monomer; and

a ratio (b/a) of a variation in a surface resistance value on a side of the pressure-sensitive adhesive layer is 5 or less, provided that:

the “a” in the ratio b/a represents a surface resistance value on the side of the pressure-sensitive adhesive layer when peeling a separator immediately after producing the pressure-sensitive adhesive layer attached polarizing film in a state where the polarizing film is provided with the pressure-sensitive adhesive layer and the pressure-sensitive adhesive layer is provided with the separator; and

the “b” in the ratio b/a represents a surface resistance value on the side of the pressure-sensitive adhesive layer when peeling the separator after placing the pressure-sensitive adhesive layer attached polarizing film in a humidified environment of 60° C.×95% RH for 250 hours and further drying the pressure-sensitive adhesive layer attached polarizing film at 40° C. for 1 hour, respectively.

In the pressure-sensitive adhesive layer attached polarizing film of the present invention, it is preferable that the inorganic cation-anion salt contains a fluorine-containing anion.

In the pressure-sensitive adhesive layer attached polarizing film of the present invention, it is preferable that a surface resistance value on the side of the pressure-sensitive adhesive layer when peeling a separator immediately after producing the pressure-sensitive adhesive layer attached polarizing film in a state where the pressure-sensitive adhesive layer is provided with the separator is from 1.0×10⁶ to 1.0×10¹²Ω/□.

In the pressure-sensitive adhesive layer attached polarizing film of the present invention, it is preferable that the polar functional group-containing monomer is a hydroxyl group-containing monomer.

In the pressure-sensitive adhesive layer attached polarizing film of the present invention, it is preferable that an anchor layer is provided between the polarizing film and the pressure-sensitive adhesive layer, and the anchor layer includes a conductive polymer.

In addition, the pressure-sensitive adhesive layer attached polarizing film of the present invention is a pressure-sensitive adhesive layer attached polarizing film for an in-cell type liquid crystal panel, which is characterized by comprising a liquid crystal cell including a liquid crystal layer containing liquid crystal molecules that are homogeneously aligned in the absence of an electric field, a first transparent substrate and a second transparent substrate sandwiching the liquid crystal layer on both sides, and a touch sensing electrode unit related to a touch sensor and touch-driven functions between the first transparent substrate and the second transparent substrate, wherein:

the pressure-sensitive adhesive layer attached polarizing film is disposed on the viewing side of the in-cell type liquid crystal cell;

the pressure-sensitive adhesive layer of the pressure-sensitive adhesive layer attached polarizing film is disposed between the polarizing film of the pressure-sensitive adhesive layer attached polarizing film and the in-cell type liquid crystal cell;

the pressure-sensitive adhesive layer is formed from a pressure-sensitive adhesive composition containing an inorganic cation-anion salt and a (meth)acrylic polymer containing, as monomer units, an alkyl (meth)acrylate and a polar functional group-containing monomer; and

a ratio (b/a) of a variation in a surface resistance value on a side of the pressure-sensitive adhesive layer is 5 or less; provided that:

the “a” in the b/a ratio represents a surface resistance value on the side of the pressure-sensitive adhesive layer when peeling a separator immediately after producing the pressure-sensitive adhesive layer attached polarizing film in a state where the polarizing film is provided with the pressure-sensitive adhesive layer and the pressure-sensitive adhesive layer is provided with the separator; and

the “b” in the b/a ratio represents a surface resistance value on the side of the pressure-sensitive adhesive layer when peeling the separator after placing the pressure-sensitive adhesive layer attached polarizing film in a humidified environment of 60° C.×95% RH for 250 hours and further drying the pressure-sensitive adhesive layer attached polarizing film at 40° C. for 1 hour, respectively.

In the pressure-sensitive adhesive layer attached polarizing film for an in-cell type liquid crystal panel according to the present invention, it is preferable that the inorganic cation-anion salt contains a fluorine-containing anion.

In the pressure-sensitive adhesive layer attached polarizing film for an in-cell type liquid crystal panel according to the present invention, it is preferable that a surface resistance value on the side of the pressure-sensitive adhesive layer when peeling a separator immediately after producing the pressure-sensitive adhesive layer attached polarizing film in a state where the pressure-sensitive adhesive layer is provided with the separator is from 1.0×10⁸ to 1.0×10¹²Ω/□.

In the pressure-sensitive adhesive layer attached polarizing film for an in-cell type liquid crystal panel according to the present invention, it is preferable that the polar functional group-containing monomer is a hydroxyl group-containing monomer.

In the pressure-sensitive adhesive layer attached polarizing film for an in-cell type liquid crystal panel according to the present invention, it is preferable that an anchor layer is provided between the polarizing film and the pressure-sensitive adhesive layer, and the anchor layer includes a conductive polymer.

That is, the in-cell type liquid crystal panel of the present invention comprises:

an in-cell type liquid crystal cell that is provided with a liquid crystal layer comprising liquid crystal molecules which are homogeneously aligned in the absence of an electric field, a first transparent substrate and a second transparent substrate sandwiching the liquid crystal layer on both sides, and a touch sensing electrode unit related to a touch sensor and touch-driven functions between the first transparent substrate and the second transparent substrate; and

a first polarizing film disposed on the viewing side of the in-cell type liquid crystal cell and a second polarizing film disposed on the opposite side of the viewing side, and a first pressure-sensitive adhesive layer disposed between the first polarizing film and the in-cell type liquid crystal cell; wherein:

the first pressure-sensitive adhesive layer is formed from a pressure-sensitive adhesive composition comprising an inorganic cation-anion salt and a (meth)acrylic polymer containing, as monomer units, an alkyl (meth)acrylate and a polar functional group-containing monomer;

a ratio (b/a) of a variation in a surface resistance value on a side of the first pressure-sensitive adhesive layer is 5 or less, provided that:

the “a” in the ratio b/a represents a surface resistance value on the side of the first pressure-sensitive adhesive layer when peeling a separator immediately after producing the pressure-sensitive adhesive layer attached first polarizing film in a state where the first polarizing film is provided with the first pressure-sensitive adhesive layer and the first pressure-sensitive adhesive layer is provided with the separator; and

the “b” in the ratio b/a represents a surface resistance value on the side of the first pressure-sensitive adhesive layer when peeling the separator after placing the pressure-sensitive adhesive layer attached first polarizing film in a humidified environment of 60° C.×95% RH for 250 hours and further drying the pressure-sensitive adhesive layer attached first polarizing film at 40° C. for 1 hour, respectively.

In the in-cell type liquid crystal panel of the present invention, it is preferable that the inorganic cation-anion salt contains a fluorine-containing anion.

In the in-cell type liquid crystal panel of the present invention, it is preferable that a surface resistance value on the side of the first pressure-sensitive adhesive layer when peeling a separator immediately after producing the pressure-sensitive adhesive layer attached first polarizing film in a state where the first pressure-sensitive adhesive layer is provided with the separator is from 1.0×10⁸ to 1.0×10¹²Ω/□.

In the in-cell type liquid crystal panel of the present invention, it is preferable that the polar functional group-containing monomer is a hydroxyl group-containing monomer.

In the in-cell type liquid crystal panel of the present invention, it is preferable that an anchor layer is provided between the first polarizing film and the first pressure-sensitive adhesive layer, and the anchor layer includes a conductive polymer.

In the in-cell type liquid crystal panel of the present invention, it is preferable that the fluorine-containing anion is a bis(fluorosulfonylimide) anion.

Further, the liquid crystal display device of the present invention preferably comprises the in-cell type liquid crystal panel.

### Effect of the Invention

Since the pressure-sensitive adhesive layer attached polarizing film on the viewing side in the in-cell type liquid crystal panel of the present invention includes a (meth) acrylic polymer specifically including a monomer and an inorganic cation-anion salt in the pressure-sensitive adhesive layer, adhesiveness (anchoring force) between the polarizing film and the pressure-sensitive adhesive layer is excellent and occurrence of cloudiness of the pressure-sensitive adhesive layer can be prevented even in a humidified environment (cloudiness prevention property under humidification). In addition, such a polarizing film is excellent also in humidification durability, and further, antistatic function is imparted, so that when a conduction structure is provided on each side surface of the pressure-sensitive adhesive layer or the like in the in-cell type liquid crystal panel, the polarizing film can be in contact with the conduction structure, and the contact area can be sufficiently secured. Therefore, the conduction on each side surface of the pressure-sensitive adhesive layer or the like can be secured, and the occurrence of electrostatic unevenness attributable to the conduction failure can be suppressed.

Further, in the pressure-sensitive adhesive layer attached polarizing film of the present invention, the ratio of the variation in the surface resistance value before and after humidification on a side of the (first) pressure-sensitive adhesive layer is also controlled to be within a predetermined range, so that it is possible to provide a predetermined antistatic function by reducing the surface resistance value on the side of the pressure-sensitive adhesive layer while controlling so as not to deteriorate the durability in a humidified environment without decreasing the touch sensor sensitivity. Therefore, the pressure-sensitive adhesive layer attached polarizing film of the present invention can satisfy the touch sensor sensitivity while having a good antistatic function.

### BRIEF DESCRIPTION OF THE DRAWINGS

FIG. 1 is a cross-sectional view showing an example of a pressure-sensitive adhesive layer attached polarizing film used on the viewing side of the in-cell type liquid crystal panel of the present invention.

FIG. 2 is a cross-sectional view showing an example of the in-cell type liquid crystal panel of the present invention.

FIG. 3 is a cross-sectional view showing an example of the in-cell type liquid crystal panel of the present invention.

FIG. 4 is a cross-sectional view showing an example of the in-cell type liquid crystal panel of the present invention.

FIG. 5 is a cross-sectional view showing an example of the in-cell type liquid crystal panel of the present invention.

FIG. 6 is a cross-sectional view showing an example of the in-cell type liquid crystal panel of the present invention.

### MODE FOR CARRYING OUT THE INVENTION

### <Pressure-Sensitive Adhesive Layer Attached Polarizing Film>

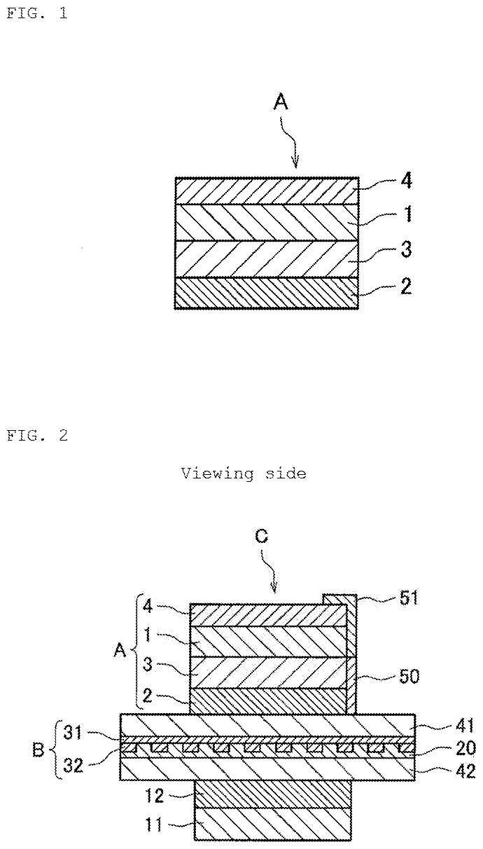

Hereinafter, the present invention will be described with reference to the drawings. As shown in FIG. 1, a pressure-sensitive adhesive layer attached polarizing film A to be used for the viewing side of the in-cell type liquid crystal panel of the present invention comprises a first polarizing film 1, an anchor layer 3, and a first pressure-sensitive adhesive layer 2 in this order (the anchor layer 3 is optionally provided). Further, a surface treatment layer 4 may be provided on the side of the first polarizing film 1 on which the anchor layer 3 is not provided. FIG. 1 illustrates a case where the pressure-sensitive adhesive layer attached polarizing film A of the present invention comprises the surface treatment layer 4. The pressure-sensitive adhesive layer attached polarizing film A is disposed on the side of a transparent substrate 41 on the viewing side of an in-cell type liquid crystal cell B shown in FIG. 2 by the pressure-sensitive adhesive layer 2. Although not shown in FIG. 1, a separator may be provided in the first pressure-sensitive adhesive layer 2 of the pressure-sensitive adhesive layer attached polarizing film A of the present invention, and a surface protective film may be provided on the first polarizing film 1.

### <First Polarizing Film>

As the first polarizing film, one comprising a transparent protective film on one side or both sides of a polarizer is generally used.

The polarizer is not particularly limited but various kinds of polarizers may be used. Examples of the polarizer include a film obtained by uniaxial stretching after a dichromatic substance, such as iodine and dichroic dye, is adsorbed to a hydrophilic high molecular weight polymer film, such as polyvinyl alcohol-based film, partially formalized polyvinyl alcohol-based film, and ethylene-vinyl acetate copolymer-based partially saponified film, a polyene-based alignment film, such as dehydrated polyvinyl alcohol and dehydrochlorinated polyvinyl chloride, and the like. Among them, a polarizer composed of a polyvinyl alcohol-based film and a dichroic substance such as iodine is suitable. Thickness of these polarizers is not particularly limited but is generally about 80 μm or less.

As a polarizer, a thin polarizer with a thickness of 10 μm or less can be used. From the viewpoint of thinning, the thickness is preferably from 1 to 7 μm. It is preferable that such a thin polarizer has less unevenness in thickness, excellent visibility, and less dimensional change, so it is excellent in durability, and furthermore, the thickness as a polarizing film can be reduced.

As a material constituting the transparent protective film, for example, a thermoplastic resin excellent in transparency, mechanical strength, thermal stability, moisture barrier property, isotropy, and the like is used. Specific examples of such thermoplastic resin include cellulose resin such as triacetyl cellulose, polyester resin, polyether sulfone resin, polysulfone resin, polycarbonate resin, polyamide resin, polyimide resin, polyolefin resin, (meth)acrylic resin, cyclic polyolefin resin (norbornene-based resin), polyarylate resin, polystyrene resin, polyvinyl alcohol resin, and mixtures thereof. In addition, a transparent protective film is bonded together by an adhesive layer on one side of the polarizer, but a (meth)acrylic, urethane-based, acrylic urethane-based, epoxy-based, or silicone-based thermosetting resin or an ultraviolet curable resin can be used on the other side as the transparent protective film. The transparent protective film may contain one or more appropriate additives.

The adhesive used to bond the polarizer and the transparent protective film is not particularly limited as long as such adhesive is optically transparent, and various aqueous, solvent-based, hot melt-based, radical curable, or cationic curable types are used. However, aqueous adhesives or radical curable type adhesives are preferred.

### <First Pressure-Sensitive Adhesive Layer>

The first pressure-sensitive adhesive layer that constitutes the in-cell type liquid crystal panel of the present invention is disposed between a first polarizing film disposed on the viewing side of the in-cell type liquid crystal cell and a second polarizing film disposed on the opposite side of the viewing side of the in-cell type liquid crystal cell, and disposed between the first polarizing film and the in-cell type liquid crystal cell. The first pressure-sensitive adhesive layer is characterized by being formed from a pressure-sensitive adhesive composition comprising an organic cation-anion salt and a (meth)acrylic polymer including, as monomer units, an alkyl (meth)acrylate and a polar functional group-containing monomer, and a ratio (b/a) of a variation in a surface resistance value on a side of the first pressure-sensitive adhesive layer is 5 or less, provided that:

the “a” in the ratio b/a represents a surface resistance value on the side of the first pressure-sensitive adhesive layer when peeling a separator immediately after producing the pressure-sensitive adhesive layer attached first polarizing film in a state where the first polarizing film is provided with the first pressure-sensitive adhesive layer and the pressure-sensitive adhesive layer is provided with the separator; and

the “b” in the ratio b/a represents a surface resistance value on the side of the pressure-sensitive adhesive layer when peeling the separator after placing the pressure-sensitive adhesive layer attached polarizing film in a humidified environment of 60° C.×95% RH for 250 hours and further drying the pressure-sensitive adhesive layer attached polarizing film at 40° C. for 1 hour, respectively.

The thickness of the first pressure-sensitive adhesive layer is from 5 to 100 μm, preferably from 5 to 50 μm, more preferably from 10 to 35 μm, from the viewpoint of securing durability and securing a contact area with the conduction structure on the side surface. With regard to the contact area with the conduction structure, in the case of providing the conduction structure on the side surface of the polarizing film in the in-cell type liquid crystal panel, the thickness of the first pressure-sensitive adhesive layer is controlled within the range, so that a contact area with the conduction structure can be secured and an excellent antistatic function is imparted, which is preferred.

The in-cell type liquid crystal panel of the present invention is characterized in that a ratio (b/a) of a variation of a surface resistance value on a side of the first pressure-sensitive adhesive layer is 5 or less. When the ratio (b/a) of the variation exceeds 5, the antistatic function of the pressure-sensitive adhesive layer in a humidified environment is reduced. The ratio (b/a) of the variation is 5 or less, preferably 4.5 or less, more preferably 4 or less, still more preferably from 0.4 to 3.5, most preferably from 0.4 to 2.5.

It is preferable that the surface resistance value on the side of the pressure-sensitive adhesive layer in the pressure-sensitive adhesive layer attached polarizing film satisfy an antistatic function of an initial value (room temperature standing condition: 23° C.×65% RH) and after humidification (e.g., placed at 60° C.×95% RH for 250 hours and further left at 40° C.×1 hour), and is controlled to 1.0×10⁶ to 1.0×10¹²Ω/□ so as to reduce the touch sensor sensitivity and not to reduce the durability under humidification and heating environment. The surface resistance value can be adjusted by controlling the surface resistance value of the first pressure-sensitive adhesive layer (single body) or of the anchor layer in the case of comprising an anchor layer with conductivity. Such surface resistance value is more preferably from 2.0×10⁸ to 8.0×10¹⁰Ω/□, still more preferably from 3.0×10⁸ to 6.0×10¹⁰Ω/□.

The pressure-sensitive adhesive for forming a first pressure-sensitive adhesive layer is characterized by being formed from a pressure-sensitive adhesive composition comprising an inorganic cation-anion salt and a (meth) acrylic polymer containing, as monomer units, an alkyl (meth) acrylate and a polar functional group-containing monomer. The acrylic pressure-sensitive adhesive is preferable because such adhesive is excellent in optical transparency, exhibits appropriate adhesive properties such as wettability, cohesion, and adhesion property, and is excellent in weather resistance and heat resistance.

The acrylic pressure-sensitive adhesive contains a (meth)acrylic polymer as a base polymer. The (meth)acrylic polymer contains, as a monomer unit, an alkyl (meth)acrylate as a main component. Incidentally, (meth)acrylate refers to acrylate and/or methacrylate and the “(meth)” is used in the same meaning in the present invention.

As the alkyl (meth)acrylate constituting the main skeleton of the (meth) acrylic polymer, linear or branched alkyl groups each having 1 to 18 carbon atoms can be exemplified. These can be used alone or in combination. The average number of carbon atoms of these alkyl groups is preferably from 3 to 9.

From the viewpoints of adhesive properties, durability, adjustment of retardation, adjustment of refractive index, and the like, an alkyl (meth) acrylate containing an aromatic ring, such as phenoxyethyl (meth) acrylate and benzyl (meth) acrylate, can be used as a copolymerization monomer.

The polar functional group-containing monomer contains any one of a carboxyl group, a hydroxyl group, a nitrogen-containing group, and an alkoxy group as a polar functional group in its structure and is also a compound containing a polymerizable unsaturated double bond such as a (meth) acryloyl group and a vinyl group. These polar functional group-containing monomers are preferable in order to suppress an increase in the surface resistance value (in particular, in a humidified environment) with time or to satisfy the durability.

In particular, among the polar functional group-containing monomers, a hydroxyl group-containing monomer is preferable for suppressing an increase in the surface resistance value over time (especially in a humidified environment) and satisfying the durability. These can be used singly or in combination.

Specific examples of the carboxyl group-containing monomer include (meth)acrylic acid, carboxyethyl (meth)acrylate, carboxypentyl (meth)acrylate, itaconic acid, maleic acid, fumaric acid, crotonic acid, and the like.

Among the carboxyl group-containing monomers, acrylic acid is preferable from the viewpoints of copolymerizability, cost, and adhesive properties.

Specific examples of the hydroxyl group-containing monomer include hydroxcyalkyl (meth)acrylates (e.g. 2-hydroxyethyl (meth)acrylate, 3-hydroxypropyl (meth)acrylate, 4-hydroxybutyl (meth)acrylate, 6-hydroxyhexyl (meth)acrylate, 8-hydroxyoctyl (meth)acrylate, 10-hydroxydecyl (meth)acrylate, 12-hydroxylauryl (meth)acrylate, etc.), (4-hydroxymethylcyclohexyl)-methylacrylate, and the like.

Among the hydroxyl group-containing monomers, 2-hydroxyethyl (meth)acrylate and 4-hydroxybutyl (meth)acrylate are preferable from the viewpoint of securing temporal stability of the surface resistance value, anchoring force, and durability, and 4-hydroxybutyl (meth)acrylate is particularly preferred.

Specific examples of the nitrogen-containing group-containing monomer include a nitrogen-containing heterocyclic compound having a vinyl group, such as N-vinyl-2-pyrrolidone, N-vinylcaprolactam, and N-acryloylmorpholine; dialkyl-substituted (meth)acrylamides such as N,N-dimethyl (meth)acrylamide, N,N-diethyl (meth)acrylamide, N,N-dipropyl acrylamide, N,N-diisopropyl (meth)acrylamide, N,N-dibutyl (meth)acrylamide, N-ethyl-N-methyl (meth)acrylamide, N-methyl-N-propyl (meth)acrylamide, and N-methyl-N-isopropyl (meth)acrylamide; dialkylamino (meth)acrylates such as N,N-dimethylaminomethyl (meth)acrylate, N,N-dimethylaminoethyl (meth)acrylate, N,N-dimethylaminopropyl (meth)acrylate, N,N-dimethylaminoisopropyl (meth)acrylate, N,N-dimethylaminobutyl (meth)acrylate, N-ethyl-N-methylaminoethyl (meth)acrylate, N-methyl-N-propylaminoethyl (meth)acrylate, N-methyl-N-isopropylaminoethyl (meth)acrylate, and N,N-dibutylaminoethyl (meth)acrylate; N, N-dialkyl-substituted aminopropyl (meth)acrylamides such as N,N-dimethylaminoproyl (meth)acrylamide, N,N-diethylaminoproyl (meth)acrylamide, N,N-dipropylaminoproyl (meth)acrylamide, N,N-diisopropylaminoproyl (meth)acrylamide, N-ethyl-N-methylaminopropyl (meth)acrylamide, N-methyl-N-propylaminopropyl (meth)acrylamide, N-methyl-N-isopropylaminopropyl (meth)acrylamide; and the like.

The nitrogen-containing group-containing monomer is preferable in terms of satisfying durability, and among the nitrogen-containing group-containing monomers, particularly preferred is an N-vinyl group-containing lactam-based monomer among nitrogen-containing heterocyclic compounds having a vinyl group.

Examples of the alkoxy group-containing monomer include 2-methoxyethyl (meth)acrylate, 2-ethoxyethyl (meth)acrylate, 2-propoxyethyl (meth)acrylate, 2-isopropoxyethyl (meth)acrylate, 2-butoxyethyl (meth)acrylate, 2-methoxypropyl (meth)acrylate, 2-ethoxypropyl (meth)acrylate, 2-propoxypropyl (meth)acrylate, 2-isopropoxypropyl (meth)acrylate, 2-butoxypropyl (meth)acrylate, 3-methoxypropyl (meth)acrylate, 3-ethoxypropyl (meth)acrylate, 3-propoxypropyl (meth)acrylate, 3-isopropoxypropyl (meth)acrylate, 3-butoxypropyl (meth)acrylate, 4-methoxybutyl (meth)acrylate, 4-ethoxybutyl (meth)acrylate, 4-propoxybutyl (meth)acrylate, 4-isopropoxybutyl (meth)acrylate, 4-butoxybutyl(meth)acrylate, and the like.

These alkoxy group-containing monomers have a structure in which an atom of the alkyl group in the alkyl (meth) acrylate is substituted with an alkoxy group.

Further, examples of the copolymerizable monomers (copolymerization monomers) other than the above include a silane-based monomer containing a silicon atom. Examples of the silane-based monomer include 3-acryloxypropyl-triethoxysilane, vinyltrimethoxysilane, vinyltriethoxysilane, 4-vinylbutyltrimethoxysilane, 4-vinylbutyltriethoxysilane, 8-vinyloctyltrimethoxysilane, 8-vinyloctyltriethoxysilane, 10-methacryloyloxydecyltrimethoxysilane, 10-acryloyloxydecyltrimethoxysilane, 10-methacryloyloxydecyl-triethoxysilane, 10-acryloyloxydecyltriethoxysilane, and the like.

As the copolymerizable monomer, it is also possible to use a polyfunctional monomer having two or more unsaturated double bonds of a (meth)acryloyl group, a vinyl group or the like, such as an esterified substance of (meth) acrylic acid and polyalcohol, wherein the esterified substance includes: tripropylene glycol di(meth)acrylate, tetraethylene glycol di(meth) acrylate, 1,6-hexanediol di(meth) acrylate, bisphenol A diglycidyl ether di(meth)acrylate, neopentyl glycol di(meth)acrylate, trimethylolpropane tri(meth)acrylate, pentaerythritol tri(meth)acrylate, pentaerythritol tetra(meth)acrylate, dipentaerythritol penta(meth)acrylate, dipentaerythritol hexa(meth)acrylate, and caprolactone-modified dipentaerythritol hexa(meth)acrylate; and polyester (meth)acrylate, epoxy (meth)acrylate and urethane (meth)acrylate obtained by adding, as the same functional group as that in the monomer component, two or more unsaturated double bonds of a (meth)acryloyl group, a vinyl group or the like, respectively, to polyester, epoxy and urethane as a backbone.

In addition, an alicyclic structure-containing monomer can be introduced into the (meth)acrylic polymer by copolymerization for the purpose of improving durability and imparting stress relaxation property. The carbon ring having an alicyclic structure in the alicyclic structure-containing monomer may have a saturated structure or may partially have an unsaturated bond. The alicyclic structure may be a monocyclic alicyclic structure or a polycyclic alicyclic structure such as a bicyclic or tricyclic structure. Examples of the alicyclic structure-containing monomer include cyclohexyl (meth)acrylate, dicyclopentanyl (meth)acrylate, adamantyl (meth)acrylate, isobornyl (meth)acrylate, dicyclopentenyl (meth)acrylate, dicyclopentenyloxyethyl (meth)acrylate, and the like. Among them, from the viewpoint of exhibiting more excellent durability, dicyclopentanyl (meth)acrylate, adamantyl (meth)acrylate or isobornyl (meth)acrylate is preferable, and isobornyl (meth)acrylate is particularly preferable.

The (meth) acrylic polymer contains alkyl (meth) acrylate as a main component and the proportion thereof at the weight ratio with respect to all the constituent monomers is preferably from 60 to 99.99% by weight, more preferably from 65 to 99.95% by weight, still more preferably from 70 to 99.9% by weight. By using the alkyl (meth) acrylate as a main component, excellent adhesive properties are achieved, which is preferable.

In the (meth)acrylic polymer, the weight ratio of the copolymerizable monomer with respect to all the constituent monomers is preferably from 0.01 to 40% by weight, more preferably from 0.05 to 35% by weight, still more preferably from 0.1 to 30% by weight.

Among these copolymerizable monomers, the hydroxyl group-containing monomer and the carboxyl group-containing monomer are preferably used from the viewpoints of adhesion property and durability. Further, the hydroxyl group-containing monomer and the carboxyl group-containing monomer can be used in combination. In the case where the pressure-sensitive adhesive composition contains a crosslinking agent, these copolymerizable monomers serve as a reactive site with the crosslinking agent. The hydroxyl group-containing monomer and the carboxyl group-containing monomer are sufficiently reactive with an intermolecular crosslinking agent, so that such a monomer is preferably used to enhance cohesion property and heat resistance of a resulting pressure-sensitive adhesive layer. The hydroxyl group-containing monomer is preferable from the viewpoint of reworkability, and the carboxyl group-containing monomer is preferable from the viewpoint of achieving both durability and reworkability.

In the case of containing the hydroxyl group-containing monomer as the copolymerizable monomer, the content thereof is preferably f rom 0.01 to 15% by weight, more preferably f rom 0.05 to 10% by weight, still more preferably from 0.1 to 5% by weight. Further, in the case of containing the carboxyl group-containing monomer as the copolymerizable monomer, the content thereof is preferably from 0.01 to 15% by weight, more preferably from 0.1 to 10% by weight, still more preferably from 0.2 to 8% by weight.

The (meth) acrylic polymer used in the present invention usually has a weight average molecular weight in the range of 500,000 to 3,000,000. Considering durability, particularly, heat resistance, the weight average molecular weight is preferably from 700,000 to 2,700,000, more preferably from 800,000 to 2,500,000. When the weight average molecular weight is smaller than 500,000, this molecular weight is not preferable from the viewpoint of heat resistance. In addition, when the weight average molecular weight is larger than 3,000,000, a large amount of diluting solvent is necessary for adjusting the viscosity for coating, and such a weight average molecular weight is not preferable, leading to an increase of cost. The weight average molecular weight is a value obtained by subjecting a measurement value from GPC (gel permeation chromatography) to a polystyrene conversion.

As regards production of the (meth)acrylic polymer, it is possible to appropriately select one of conventional production methods such as solution polymerization, bulk polymerization, emulsion polymerization and various radical polymerizations. The resulting (meth)acrylic polymer may be any type of copolymers such as a random copolymer, a block copolymer, and a graft copolymer.

Further, as the pressure-sensitive adhesive for forming a first pressure-sensitive adhesive layer, various other pressure-sensitive adhesives can be used in addition to the acrylic pressure-sensitive adhesive as long as the characteristics of the present invention are not impaired. Examples of the pressure-sensitive adhesives include rubber-based pressure-sensitive adhesives, silicone-based pressure-sensitive adhesives, urethane-based pressure-sensitive adhesives, vinyl alkyl ether-based pressure-sensitive adhesives, polyvinylpyrrolidone-based pressure-sensitive adhesives, polyacrylamide-based pressure-sensitive adhesives, cellulose-based pressure-sensitive adhesives, and the like. A pressure-sensitive adhesive base polymer is selected depending on the type of the pressure-sensitive adhesives.

### <Inorganic Cation-Anion Salt (Alkali Metal Salt)>

The inorganic cation-anion salt used in the present invention is composed of a cation component and an anion component, and the cation component is made of an inorganic substance. In the present invention, “inorganic cation-anion salt” generally indicates an alkali metal salt formed from an alkali metal cation and an anion, and as the alkali metal salt, organic salts and inorganic salts of alkali metals can be used. By using the inorganic cation-anion salt, the adhesiveness between the pressure-sensitive adhesive layer and the polarizing film or the anchor layer is maintained, which is advantageous for the durability under humidification and heating environment, and this is a preferable embodiment. As an alkali metal ion which constitutes the cation part of an alkali metal salt, each ion of lithium, sodium, and potassium is mentioned. Among these alkali metal ions, lithium ion is preferable.

The anion moiety of the alkali metal salt may be composed of an organic substance or an inorganic substance. Examples of the anion moiety constituting the organic salt include CH₃COO⁻, CF₃COO⁻, CH₃SO₃⁻, CF₃SO₃⁻, (CF₃SO₂)₃C⁻, C₄F₉SO₃⁻, C₃F₇COO⁻, (CF₃SO₂)(CF₃CO)N⁻, ⁻O₃S(CF₂)₃SO₃⁻, PF₆⁻, CO₃²⁻, and the following general formulas (1) to (4):

(1): (CₙF₂ₙ₊₁SO₂)₂N⁻ (wherein n is an integer of from 1 to 10),

(2): CF₂(CₘF₂ₘSO₂)₂N⁻ (wherein m is an integer of from 1 to 10),

(3): ⁻O₃S(CF₂)ₗSO₃⁻ (wherein l is an integer of from 1 to 10),

(4): (CₚF₂ₚ₊₁SO₂)N⁻(C_{q}F_{2q+1}SO₂) (wherein p and q are each an integer of from 1 to 10), and (FSO₂)₂N⁻, and the like. In particular, an anion moiety containing a fluorine atom is preferably used since such a moiety is able to give an ionic compound having a good ion dissociation property. Examples of the anion moiety constituting the inorganic salt to be used include Cl⁻, Br⁻, I⁻, Al₂Cl₄⁻, Al₂Cl₇⁻, BF₄⁻, PF₆⁻, ClO₄⁻, NO₃⁻, AsF₆⁻, SbF₆⁻, NbF₆⁻, TaF₆⁻, (CN)₂N⁻, and the like. Among the anions containing a fluorine atom, a fluorine-containing imide anion is preferable, and among these, a bis(trifluoromethanesulfonyl)imide anion and a bis(fluorosulfonyl)imide anion are preferable. In particular, bis(fluorosulfonyl)imide anion is preferable because such imide can impart excellent antistatic properties in a relatively small addition amount, maintains adhesive properties, and is advantageous for durability under humidification and heating environment.

Specific examples of the alkali metal organic salt include preferably sodium acetate, sodium alginate, sodium lignin sulfonate, sodium toluene sulfonate, LiCF₃SO₃, Li(CF₃SO₂)₂N, Li(CF₃SO₂)₂N, Li(C₂F₅SO₂)₂N, Li(C₄F₉SO₂)₂N, Li(CF₃SO₂)₃C, KO₃S(CF₂)₃SO₃K, and LiO₃S(CF₂)₃SO₃K. Of these, LiCF₃SO₃, Li(CF₃SO₂)₂N, Li(C₂FSO₂)₂N, Li(C₄F₉SO₂)₂N, Li(CF₃SO₂)₃C, and the like are preferable, and fluorine-containing lithium imide salts such as Li(CF₃SO₂)₂N, Li(C₂F₅O₂)₂N, and Li(C₄F₉SO₂)₂N are more preferable, and bis(fluoromethanesulfonylimide) lithium salt is particularly preferable.

Moreover, as an inorganic salt of an alkali metal, there are mentioned lithium perchlorate and lithium iodide.

Further, in addition to the inorganic cation-anion salt as an antistatic agent, other antistatic agents can be used as long as they are within a range which does not impair the characteristic of the present invention. For example, organic cation-anion salts can be used as other antistatic agents. In addition, an ionic compound (organic cation-anion salt) containing an organic cation tends to be inferior to adhesiveness (anchoring force) between the polarizing film and the pressure-sensitive adhesive layer when used as compared to an inorganic cation-anion salt. Therefore, when improving adhesiveness etc., it is a preferable embodiment not to use an organic cation-anion salt. In particular, in the case of comprising an anchor layer, there is a possibility that adhesiveness (anchoring force) between the anchor layer and the pressure-sensitive adhesive layer may be significantly reduced, and it is therefore preferable not to use an organic cation-anion salt.

### <Organic Cation-Anion Salt>

The organic cation-anion salt used in the present invention is composed of a cation component and an anion component, and the cation component is composed of an organic substance. In the present invention, the term “organic cation-anion salt” refers to an organic salt in which the cation part is composed of an organic substance, and the anion part may be an organic substance or an inorganic substance. The “organic cation-anion salt” is also referred to as an ionic liquid or an ionic solid.

Specific examples of the cation component include a pyridinium cation, a piperidinium cation, a pyrrolidinium cation, a cation having a pyrroline skeleton, a cation having a pyrrole skeleton, an imidazolium cation, a tetrahydropyrimidinium cation, a dihydropyrimidinium cation, a pyrazolium cation, a pyrazolinium cation, a tetraalkylammonium cation, a trialkylsulfonium cation, a tetraalkylphosphonium cation, and the like.

Examples of the anion component to be used include Cl⁻, Br⁻, I⁻, AlCl₄⁻, Al₂Cl₇⁻, BF₄⁻, PF₆⁻, ClO₄⁻, NO₃⁻, CH₃COO⁻, CF₃COO⁻, CH₃SO₃⁻, CF₃SO₃⁻, (CF₃SO₂)₃C⁻, AsF₆⁻, SbF₆⁻, NbF₆⁻, TaF₆⁻, (CN)₂N⁻, C₄F₉SO₃⁻, C₃F₇COO⁻, (CF₃SO₂)(CF₃CO)N⁻, ⁻O₃S(CF₂)₃SO₃⁻, and the following general formulas (1) to (4):

(1): (CₙF₂ₙ₊₁SO₂)₂N⁻ (wherein n is an integer of from 1 to 10),
(2): CF₂(CₘF₂ₘSO₂)₂N⁻ (wherein m is an integer of from 1 to 10),
(3): ⁻O₃S(CF₂)ₗSO₃⁺ (wherein 1 is an integer of from 1 to 10),
(4): (CₚF₂ₚ₊₁SO₂)N⁻(C_{q}F_{2q+1}SO₂) (wherein p and q are each an integer of from 1 to 10), and (FSO₂)₂N⁻, and the like. Among them, an anion component containing a fluorine atom (fluorine-containing anion) is particularly preferably used because an ionic compound having a good ion dissociation property can be obtained.

In addition to the inorganic cation-anion salt (alkali metal salt) and the organic cation-anion salt (ionic liquid, etc.), examples of the ionic compound include inorganic salts such as ammonium chloride, aluminum chloride, copper chloride, ferrous chloride, ferric chloride, ammonium sulfate and the like. These ionic compounds can be used singly or in combination of two or more kinds thereof.

In addition to the inorganic cation-anion salt, examples of materials that can be used as an antistatic agent include materials that can impart antistatic properties, such as ionic surfactants, conductive polymers, and conductive microparticles.

Further, as other antistatic agents, there are exemplified polymers having an ion conductive group, such as a homopolymer of a monomer having an ion conductive group such as acetylene black, ketjen black, natural graphite, artificial graphite, titanium black, cation type (quaternary ammonium salt etc.), amphoteric type (betaine compound etc.), anion type (sulfonic acid salt etc.) or nonionic type (glycerin etc.), and a copolymer of the monomer and another monomer; an ion conductive polymer having a site derived from an acrylate or a methacrylate having a quaternary ammonium base; and a permanent antistatic agent of a type in which a hydrophilic polymer such as a polyethylene methacrylate copolymer is alloyed to an acrylic resin or the like.

The amount of the inorganic cation-anion salt used is preferably in the range of from 0.05 to 20 parts by weight with respect to 100 parts by weight of the base polymer (for example, (meth) acrylic polymer) of the pressure-sensitive adhesive. It is preferable to use the inorganic cation-anion salt in the above range in order to improve the antistatic performance. On the other hand, when the amount of the inorganic cation-anion salt exceeds 20 parts by weight and the pressure-sensitive adhesive layer or the in-cell type liquid crystal panel comprising the pressure-sensitive adhesive layer is exposed to a humidified environment, problems in appearance such as precipitation and segregation of the inorganic cation-anion salt and cloudiness in a humidified environment, as well as foaming and peeling occurs in a humidified and heated environment. As a result, the durability may not be sufficient, which is not preferable. Moreover, when an anchor layer is provided, there exists a possibility that the adhesiveness (anchoring force) between the anchor layer and the pressure-sensitive adhesive layer may be decreased, and this is not desirable. Furthermore, the inorganic cation-anion salt is preferably 0.1 parts by weight or more, and more preferably 1 part by weight or more. In order to satisfy the durability, it is preferable to use the inorganic cation-anion salt in an amount of 18 parts by weight or less, and more preferably 16 parts by weight or less.

The pressure-sensitive adhesive composition for forming the first pressure-sensitive adhesive layer can contain a crosslinking agent corresponding to the base polymer. For example, when a (meth)acrylic polymer is used as the base polymer, an organic crosslinking agent or a polyfunctional metal chelate can be used as the crosslinking agent. Examples of the organic crosslinking agent include isocyanate type crosslinking agents, peroxide type crosslinking agents, epoxy type crosslinking agents, imine type crosslinking agents and the like. The polyfunctional metal chelate is one in which a polyvalent metal is covalently or coordinately bonded to an organic compound. As the polyvalent metal atom, there can be mentioned, for example, Al, Cr, Zr, Co, Cu, Fe, Ni, V, Zn, In, Ca, Mg, Mn, Y, Ce, Sr, Ba, Mo, La, Sn, Ti. The covalently or coordinately bonded atom in the organic compound may be an oxygen atom. Examples of the organic compound include alkyl esters, alcohol compounds, carboxylic acid compounds, ether compounds, ketone compounds, and the like.

The amount of the crosslinking agent to be used is preferably 3 parts by weight or less, more preferably from 0.01 to 3 parts by weight, still more preferably from 0.02 to 2 parts by weight, even still more preferably from 0.03 to 1 part by weight, per 100 parts by weight of the (meth) acrylic polymer.

The pressure-sensitive adhesive composition for forming a first pressure-sensitive adhesive layer may contain a silane coupling agent and other additives. For example, polyether compounds of polyalkylene glycol such as polypropylene glycol, powders such as colorants and pigments, dyes, surfactants, plasticizers, tackifiers, surface lubricants, leveling agents, softeners, antioxidants, anti-aging agents, light stabilizers, ultraviolet absorbers, polymerization inhibitors, inorganic or organic fillers, metal powder, particulates, foil-like materials, and the like. In addition, a redox system in which a reducing agent is added may be adopted within a controllable range. These additives are preferably used in an amount of 5 parts by weight or less, more preferably 3 parts by weight or less, still more preferably 1 part by weight or less, with respect to 100 parts by weight of the (meth)acrylic polymer.

### <Anchor Layer>

In the pressure-sensitive adhesive layer attached first polarizing film constituting the in-cell type liquid crystal panel of the present invention, an anchor layer can be provided between the first polarizing film and the first pressure-sensitive adhesive layer. The anchor layer preferably includes a conductive polymer. Since the anchor layer has conductivity (antistatic property), the antistatic function is excellent as compared with the case where the pressure-sensitive adhesive layer alone provides the antistatic property, also enabling to keep the amount of the antistatic agent used in the pressure-sensitive adhesive layer small, and this is a preferable embodiment from the viewpoint of durability and the problems of appearance such as precipitation and segregation of the antistatic agent and cloudiness in a humidified environment. In addition, in the case where a conduction structure is provided on the side surface of the pressure-sensitive adhesive layer attached first polarizing film constituting an in-cell type liquid crystal panel, it is preferable that since the anchor layer has conductivity, a contact area with the conduction structure can be secured as the antistatic layer (conductive layer) as compared with the case where the pressure-sensitive adhesive layer alone provides the antistatic property, and thus the antistatic function is excellent.

The thickness of the anchor layer is preferably from 0.01 to 0.5 μm, more preferably from 0.01 to 0.4 μm, still more preferably from 0.02 to 0.3 μm from the viewpoints of stability of the surface resistance value, and adhesiveness with the pressure-sensitive adhesive layer, as well as stability of the antistatic function by securing the contact area with the conduction structure.

The surface resistance value of the anchor layer is preferably from 1.0×10⁸ to 1.0×10¹⁰ □/Ω, more preferably from 1.0×10⁸ to 8.0×10⁹Ω/□, still more preferably from 2.0×10⁸ to 6.0×10⁹Ω/□, from the viewpoints of the antistatic function and touch sensor sensitivity.

The conductive polymers are preferably used from the viewpoints of optical properties, appearance, antistatic effect, and stability of antistatic effects during heating or humidification. In particular, conductive polymers such as polyaniline and polythiophene are preferably used. Those which are soluble in an organic solvent or water or are dispersible in water can be appropriately used as a conductive polymer, but a water-soluble conductive polymer or a water-dispersible conductive polymer is preferably used. The water-soluble conductive polymer and the water-dispersible conductive polymer can be prepared as an aqueous solution or an aqueous dispersion of a coating liquid for forming the antistatic layer and the coating liquid does not need to use a nonaqueous organic solvent. Thus, deterioration of the optical film substrate due to the organic solvent can be suppressed. The aqueous solution or aqueous dispersion may contain an aqueous solvent in addition to water. For example, it is possible to use alcohols such as methanol, ethanol, n-propanol, isopropanol, n-butanol, isobutanol, sec-butanol, tert-butanol, n-amyl alcohol, isoamyl alcohol, sec-amyl alcohol, tert-amyl alcohol, 1-ethyl-1-propanol, 2-methyl-1-butanol, n-hexanol, and cyclohexanol.

In addition, it is preferable that the water-soluble conductive polymer or the water-dispersible conductive polymer such as polyaniline and polythiophene has a hydrophilic functional group in the molecule. Examples of the hydrophilic functional group include a sulfone group, an amino group, an amide group, an imino group, a quaternary ammonium salt group, a hydroxyl group, a mercapto group, a hydrazino group, a carboxyl group, a sulfate group, a phosphate group, or salts thereof. By having a hydrophilic functional group in the molecule, the conductive polymer is easily dissolved in water or easily dispersed to microparticles in water, thereby to be able to easily prepare the water-soluble conductive polymer or water-dispersible conductive polymer. In general, when using a polythiophene-based polymer, polystyrene sulfonic acid is normally used in combination.

Examples of commercially available water-soluble conductive polymers include polyaniline sulfonic acid (weight average molecular weight in terms of polystyrene: 150,000, manufactured by Mitsubishi Rayon Co., Ltd.) and the like. Examples of commercially available water-dispersible conductive polymers include polythiophene-based conductive polymers (trade name: DENATRON series, manufactured by Nagase ChemteX Corporation) and the like.

As a material for forming the anchor layer, a binder component can be added together with the conductive polymer for the purpose of improving the film forming property of the conductive polymer, the adhesiveness to an optical film, and the like. In the case where the conductive polymer is an aqueous material such as a water-soluble conductive polymer or a water-dispersible conductive polymer, a water-soluble or water-dispersible binder component is used. Examples of the binder include oxazoline group-containing polymers, polyurethane-based resins, polyester-based resins, acrylic resins, polyether-based resins, cellulose-based resins, polyvinyl alcohol-based resins, epoxy resins, polyvinyl pyrrolidone, polystyrene-based resins, polyethylene glycol, pentaerythritol, and the like. In particular, polyurethane-based resins, polyester-based resins and acrylic resins are preferred. One or two or more kinds of these binders can be appropriately used according to the intended application.

The amount of each of the conductive polymer and the binder to be used is preferably controlled so that the surface resistance value of the resulting anchor layer is within a range of from 1.0×10⁸ to 1.0×10¹⁰Ω/□ depending on the kind of the conductive polymer and the binder.

### <Surface Treatment Layer>

The surface treatment layer can be provided, for example, on the side of the first polarizing film where the first pressure-sensitive adhesive layer is not provided. The surface treatment layer can be provided on a transparent protective film used for the first polarizing film or can be provided separately from the transparent protective film. As the surface treatment layer, there can be provided a hard coat layer, an antiglare layer, an antireflective layer, an anti-sticking layer, and the like.

The surface treatment layer is preferably a hard coat layer. As a material for forming the hard coat layer, for example, a thermoplastic resin or a material which is cured by heat or radiation can be used. Examples of such materials include thermosetting resins and radiation-curable resins such as ultraviolet curable resins and electron beam curable resins. Among them, ultraviolet curable resins are preferred, which can efficiently form a cured resin layer by a simple processing operation at the time of curing by ultraviolet radiation. Examples of such curable resins include a variety of resins such as polyester-based resins, acrylic resins, urethane-based resins, amide-based resins, silicone-based resins, epoxy-based resins, and melamine-based resins, including monomers, oligomers, and polymers thereof. In particular, radiation curable resins, specifically ultraviolet curable resins are preferred, because of high processing speed and less thermal damage to the base material. The ultraviolet curable resin to be preferably used is, for example, one having an ultraviolet-polymerizable functional group, particularly one containing an acrylic monomer or oligomer component having 2 or more, particularly 3 to 6 of such functional groups. In addition, a photopolymerization initiator is blended in the ultraviolet curable resin.

Further, as the surface treatment layer, an antiglare treatment layer or an antireflection layer can be provided for the purpose of improving visibility. An antiglare layer and an antireflection layer may be provided on the hard coat layer. The constituent material of the antiglare treatment layer is not particularly limited, and for example, a radiation curable resin, a thermosetting resin, a thermoplastic resin, or the like can be used. As the antireflection layer, titanium oxide, zirconium oxide, silicon oxide, magnesium fluoride or the like is used. Multiple layers can be provided for the antireflection layer. Other examples of the surface treatment layer include an anti-sticking layer and the like.

The surface treatment layer can be provided with conductivity by containing an antistatic agent. Examples of the antistatic agent that can be used include the above inorganic cation-anion salts, other antistatic agents, and the like.

### <Other Layers>

In the pressure-sensitive adhesive layer attached polarizing film of the present invention, in addition to the above-mentioned layers, for example, when an anchor layer is provided on one side of the first polarizing film, an easy adhesion layer is provided on the surface of the anchor layer side or various easy adhesion treatments such as corona treatment and plasma treatment can be applied thereto.

<In-Cell Type Liquid Crystal Cell and in-Cell Type Liquid Crystal Panel>

In-cell type liquid crystal cell B and in-cell type liquid crystal panel C will be described below.

### (In-Cell Type Liquid Crystal Cell B)

As shown in FIGS. 2 to 6, an in-cell type liquid crystal cell B includes a liquid crystal layer 20 containing liquid crystal molecules homogeneously aligned in the absence of an electric field, a first transparent substrate 41 and a second transparent substrate 42 sandwiching the liquid crystal layer 20 on both sides. In addition, a touch sensing electrode unit related to a touch sensor and touch-driven functions is provided between the first transparent substrate 41 and the second transparent substrate 42.

As shown in FIGS. 2, 3, and 6, the touch sensing electrode unit can be formed by a touch sensor electrode 31 and a touch driving electrode 32. The touch sensor electrode referred to herein means a touch detection (reception) electrode. The touch sensor electrode 31 and the touch driving electrode 32 can be independently formed in various patterns. For example, when the in-cell type liquid crystal cell B is a flat surface, it can be disposed in a pattern intersecting at right angles in a form independently provided in the X axis direction and the Y axis direction, respectively. In FIGS. 2, 3, and 6, the touch sensor electrode 31 is disposed on the side (viewing side) of the first transparent substrate 41 with respect to the touch driving electrode 32, but contrary to the above, the touch driving electrode 32 can be disposed on the side of the first transparent substrate 41 (viewing side) with respect to the touch sensor electrode 31.

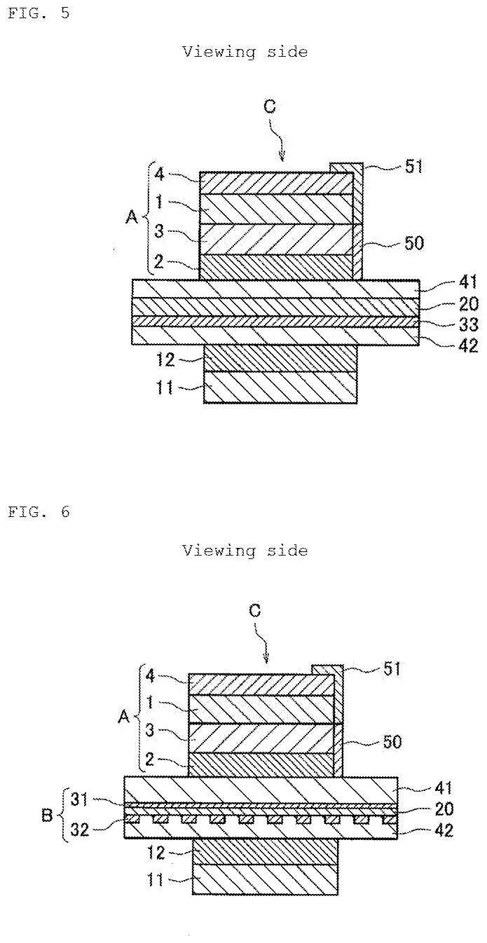

On the other hand, as shown in FIGS. 4 and 5, an electrode 33 in which a touch sensor electrode and a touch driving electrode are integrally formed can be used in the touch sensing electrode unit.

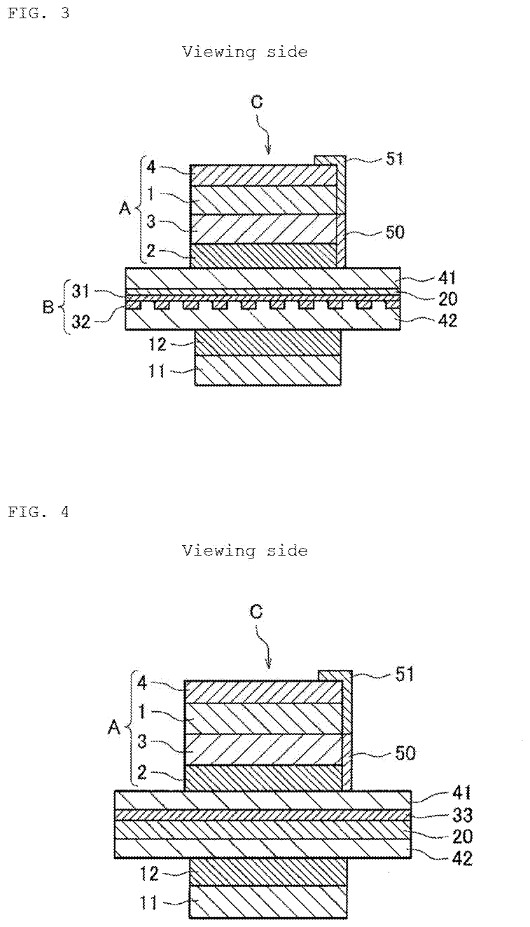

The touch sensing electrode unit may be disposed between the liquid crystal layer 20 and the first transparent substrate 41 or the second transparent substrate 42. Each of FIGS. 2 and 4 shows a case where the touch sensing electrode unit is disposed between the liquid crystal layer 20 and the first transparent substrate 41 (on the viewing side of the liquid crystal layer 20). FIGS. 3 and 5 show a case where the touch sensing electrode unit is disposed between the liquid crystal layer 20 and the second transparent substrate 42 (on the backlight side of the liquid crystal layer 20).

As shown in FIG. 6, the touch sensing electrode unit is able to have the touch sensor electrode 31 between the liquid crystal layer 20 and the first transparent substrate 41, and have the touch driving electrode 32 between the liquid crystal layer 20 and the second transparent substrate 42.

Note that a driving electrode in the touch sensing electrode unit (the touch driving electrode 32, the electrode 33 integrally formed with the touch sensor electrode and the touch driving electrode) can also serve as a common electrode for controlling the liquid crystal layer 20.

As the liquid crystal layer 20 used for the in-cell type liquid crystal cell B, a liquid crystal layer containing liquid crystal molecules homogeneously aligned in the absence of an electric field is used. As the liquid crystal layer 20, for example, an IPS type liquid crystal layer is suitably used. Besides, for the liquid crystal layer 20, for example, any type of liquid crystal layer, such as TN type, STN type, π type, VA type or the like, can be used. The thickness of the liquid crystal layer 20 is, for example, about from 1.5 μm to 4 μm.

As described above, the in-cell type liquid crystal cell B has the touch sensing electrode unit related to the touch sensor and the touch-driven function in the liquid crystal cell and does not have the touch sensor electrode outside the liquid crystal cell. That is, a conductive layer (the surface resistance value is 1×10¹³Ω/□ or less) is not provided on the viewing side (the liquid crystal cell side of the first pressure sensitive adhesive layer 2 of the in-cell type liquid crystal panel C) from the first transparent substrate 41 of the in-cell type liquid crystal cell B. Incidentally, in the in-cell type liquid crystal panel C shown in FIGS. 2 to 6, the order of each configuration is shown, but the in-cell type liquid crystal panel C can have other configurations as appropriate. A color filter substrate can be provided on the liquid crystal cell (the first transparent substrate 41).

Examples of the material for forming the transparent substrate include glass or polymer film. Examples of the polymer film include polyethylene terephthalate, polycycloolefin, polycarbonate, and the like. When the transparent substrate is formed of glass, its thickness is, for example, about from 0.1 mm to 1 mm. When the transparent substrate is formed of a polymer film, its thickness is, for example, about from 10 μm to 200 μm. The transparent substrate may have an easy adhesion layer or a hard coat layer on its surface.

The touch sensing electrode unit is formed as a transparent conductive layer from the touch sensor electrode 31 (electrostatic capacitance sensor) and the touch driving electrode 32, or from the electrode 33 integrally formed with the touch sensor electrode and the touch driving electrode. The constituent material of the transparent conductive layer is not particularly limited, and examples thereof include metals such as gold, silver, copper, platinum, palladium, aluminum, nickel, chromium, titanium, iron, cobalt, tin, magnesium, and tungsten, and alloys thereof. Examples of the constituent material of the transparent conductive layer include metal oxides such as oxides of metals (e.g. indium, tin, zinc, gallium, antimony, zirconium, and cadmium), specifically including indium oxide, tin oxide, titanium oxide, cadmium oxide, and a mixture of these metal oxides. Other metal compounds such as copper iodide and the like are used. The metal oxide may further contain an oxide of the metal atom shown in the above group, if necessary. For example, indium oxide (ITO) containing tin oxide, tin oxide containing antimony, etc. are preferably used, and ITO is particularly preferably used. The ITO preferably contains from 80 to 99% by weight of indium oxide and from 1 to 20% by weight of tin oxide.

The electrode (the touch sensor electrode 31, the touch driving electrode 32, and the electrode 33 formed integrally with the touch sensor electrode and the touch driving electrode) relating to the touch sensing electrode unit can be formed as a transparent electrode pattern usually on the inside of the first transparent substrate 41 and/or the second transparent substrate 42 (on the side of the liquid crystal layer 20 in the in-cell type liquid crystal cell B) by a conventional method. The transparent electrode pattern is usually electrically connected to a lead wiring (not shown) formed at an end portion of the transparent substrate, and the lead wiring is connected to a controller IC (not shown). The shape of the transparent electrode pattern may be any shape such as a stripe shape or a rhombic shape, in addition to a comb shape, depending on the application. The height of the transparent electrode pattern is, for example, from 10 nm to 100 nm and the width is from 0.1 mm to 5 mm.

### (In-Cell Type Liquid Crystal Panel C)

As shown in FIGS. 2 to 6, the in-cell type liquid crystal panel C of the present invention is able to have a pressure-sensitive adhesive layer attached polarizing film A on the viewing side of the in-cell type liquid crystal cell B, and a second polarizing film 11 on the opposite side thereof. The pressure-sensitive adhesive layer attached polarizing film A is disposed on the side of the first transparent substrate 41 of the in-cell type liquid crystal cell B with the first pressure-sensitive adhesive layer 2 interposed therebetween without a conductive layer interposed therebetween. On the other hand, on the side of the second transparent substrate 42 of the in-cell type liquid crystal cell B, the second polarizing film 11 is disposed with the second pressure-sensitive adhesive layer 12 interposed therebetween. The first polarizing film 1 and the second polarizing film 11 in the pressure-sensitive adhesive layer attached polarizing film A are disposed so that the transmission axes (or absorption axes) of the respective polarizers are orthogonal to each other on both sides of the liquid crystal layer 20.

As the second polarizing film 11, those described for the first polarizing film 1 can be used. The second polarizing film 11 to be used may be the same as or different from the first polarizing film 1.

For forming the second pressure-sensitive adhesive layer 12, the pressure-sensitive adhesive described for the first pressure-sensitive adhesive layer 2 can be used. The pressure-sensitive adhesive used for forming the second pressure-sensitive adhesive layer 12 may be the same as or different from the first pressure-sensitive adhesive layer 2. The thickness of the second pressure-sensitive adhesive layer 12 is not particularly limited, and is, for example, approximately from 1 to 100 μm, preferably from 2 to 50 μm, more preferably from 2 to 40 μm, and still more preferably from 5 to 35 μm.

In an in-cell type liquid crystal panel C, a conduction structure 50 can be provided on the side surfaces of the anchor layer 3 and the first pressure-sensitive adhesive layer 2 of the pressure-sensitive adhesive layer attached polarizing film A. The conduction structure 50 may be provided on the entire side surface of the anchor layer 3 and the first pressure-sensitive adhesive layer 2 or may be provided on a part thereof. In the case where the conduction structure is provided in part, it is preferable that the conduction structures is provided in a proportion of preferably 1 area % or more, more preferably 3 area % or more, of the area of the side surface in order to ensure conduction on the side surface. In addition to the above, as shown in FIG. 2, the conductive material 51 can be provided on the side surface of the first polarizing film 1.

It is possible to suppress the occurrence of static electricity by connecting an electric potential to the other suitable portion from the side surface of the anchor layer 3 and the first pressure-sensitive adhesive layer 2 by the conduction structure 50. As a material for forming the conduction structures 50 and 51, for example, a conductive paste such as silver paste, gold paste or other metal paste can be mentioned, and other conductive adhesives or any other suitable conductive materials can be used. The conduction structure 50 can be formed, for example, in a linear shape extending from the side surface of the anchor layer 3 and the first pressure-sensitive adhesive layer 2. The conduction structure 51 can also be formed in the same linear shape.

In addition, the first polarizing film 1 disposed on the viewing side of the liquid crystal layer 20, and the second polarizing film 11 disposed on the side opposite to the viewing side of the liquid crystal layer 20 can be used by laminating other optical films, depending on the suitability of each arrangement position. As the other optical film which may be used for forming a liquid crystal display device or the like, there are exemplified those capable of forming an optical film layer, such as a reflector, an anti-transmission plate, a retardation film (including wavelength plates such as ½ and ¼), a visual compensation film, and a brightness enhancement film. These can be used in one layer or in two or more layers.

### (Liquid Crystal Display Device)

The liquid crystal display device using the in-cell type liquid crystal panel (liquid crystal display device with a built-in touch sensing function) of the present invention can use appropriately members which form a liquid crystal display device, such as those using a backlight or reflector for lighting system.

### EXAMPLES

Hereinafter, the present invention will be specifically described by way of Production Examples and Examples, but the present invention is not limited by these Examples. All parts and % in each Example are based on weight. The following “initial value” (room temperature standing condition) is a value in a state left standing at 23° C.×65% RH and the value “after humidification” refers to a value measured after charging in a humidified environment of 60° C.×95% RH for 250 hours and further drying at 40° C. for 1 hour.

### (Preparation of Polarizing Film)

A 30 μm-thick polyvinyl alcohol film was immersed in warm water of 30° C. for 60 seconds to be swollen. Thereafter, the film was immersed in a 0.3% aqueous solution of iodine/potassium iodide (weight ratio=0.5/8) and stretched to 3.5 times. Then, the stretched film was further stretched to attain a total stretching ratio of 6 times while being immersed in an aqueous boric acid solution of 65° C. After stretching, the film was dried in an oven at 40° C. for 3 minutes to obtain a 12 μm-thick polarizer. A 25 μm-thick saponified triacetyl cellulose (TAC) film on one side of the polarizer, and a corona-treated 13 μm-thick cycloolefin polymer (COP) film on another side were bonded together with an ultraviolet curable acrylic adhesive to prepare a polarizing film.

Corona treatment (0.1 kw, 3 m/min, 300 mm width) was performed as an easy adhesion treatment on the pressure-sensitive adhesive layer- or the anchor layer-forming surface side (cyclo-olefin polymer (COP) film side) of the polarizing film.

### (Preparation of Forming Material of Anchor Layer)

A solution (8.6 parts) containing, as a solid content, 30 to 90% by weight of an urethane-based polymer and 10 to 50% by weight of a thiophene-based polymer (trade name: DENATRON P-580W, manufactured by Nagase ChemteX Corporation), 1 part of a solution containing 10 to 70% by weight of an oxazoline group-containing acrylic polymer and 10 to 70% by weight of polyoxyethylene group-containing methacrylate (trade name: EPOCROS WS-700, manufactured by Nippon Shokubai Co., Ltd.), and 90.4 parts of water were mixed to prepare a coating solution having a solid content concentration of 0.5% by weight for forming an anchor layer.

### (Formation of Anchor Layer)

The coating solution for forming an anchor layer was applied to one side of the polarizing film such that the thickness after drying became 0.1 μm, and dried at 80° C. for 2 minutes to form an anchor layer. Moreover, the surface resistance value of the anchor layer was 5.6×10⁸Ω/□.

### Example 1

### (Preparation of Acrylic Polymer)

A monomer mixture containing 99 parts of butyl acrylate (BA) and 1 part of 4-hydroxybutyl acrylate (HBA) was charged into a four-necked flask equipped with a stirring blade, a thermometer, a nitrogen gas inlet tube and a condenser. To 100 parts (solid content) of the monomer mixture, 0.1 parts of 2,2′-azobisisobutyronitrile as a polymerization initiator were charged together with 100 parts of ethyl acetate, and nitrogen gas was introduced thereto with gentle stirring. After purging the inside of the flask with nitrogen gas, a polymerization reaction was carried out for 8 hours while keeping the liquid temperature in the flask at around 55° C. to prepare an acrylic polymer solution.

### (Preparation of Pressure-Sensitive Adhesive Composition)

An ionic compound was blended in the amount (solid content, active ingredient) shown in Table 1 with respect to 100 parts (solid content) of the acrylic polymer solution obtained above, and 0.2 parts of an isocyanate crosslinking agent (TAKENATE D160N, trimethylolpropane hexamethylene diisocyanate, manufactured by Mitsui Chemicals, Inc.), 0.3 parts of benzoyl peroxide (NYPER BMT, manufactured by NOF Corporation), and 0.1 parts of a silane coupling agent (X-41-1810, manufactured by Shin-Etsu Chemical Co., Ltd.) were blended thereto to prepare a solution of acrylic pressure-sensitive adhesive composition used in each of Examples and Comparative Examples.

Abbreviations of the monomer components (polymer compositions) and the ionic compounds described in Table 1 are as follows.

### (Monomer Component)

BA: Butyl acrylate

PEA: Phenoxyethyl acrylate

NVP: N-vinyl-2-pyrrolidone (polar functional group-containing monomer)

AA: Acrylic acid (polar functional group-containing monomer)

HBA: 4-hydroxybutyl acrylate (polar functional group-containing monomer)

HEA: 2-hydroxyethyl acrylate (polar functional group-containing monomer)

### (Ionic Compound)

Li-PSI: Lithium bis(fluorosulfonyl)imide, manufactured by Daiichi Kogyo Seiyaku Co., Ltd., alkali metal salt (inorganic cation-anion salt)

Li-TFSI: Lithium bis(trifluoromethanesulfonyl)imide, manufactured by Mitsubishi Chemical Materials, alkali metal salt (inorganic cation-anion salt)

MPP-TFSI: Methyl propyl pyrrolidinium bis(trifluoromethanesulfonyl)imide, manufactured by Mitsubishi Materials Corporation, ionic liquid (organic cation-anion salt)

EMI-FSI: 1-Ethyl-3-methylimidazolium bis(trifluoromethanesulfonyl)imide, manufactured by Daiichi Kogyo Seiyaku Co., Ltd., ionic liquid (organic cation-anion salt)

### (Formation of Pressure-Sensitive Adhesive Layer)

Next, the solution of the acrylic pressure-sensitive adhesive composition was coated onto one surface of a polyethylene terephthalate (PET) film (separator film; trade name: MRF38, manufactured by Mitsubishi Polyester Film, Inc.) treated with a silicone release agent so that the thickness of the pressure-sensitive adhesive layer after drying was 23 μm, and then dried at 155° C. for 1 minute. In this way, a pressure-sensitive adhesive layer was formed on the surface of the separator film. Next, the pressure-sensitive adhesive layer formed on the separator film was transferred onto the polarizing film. Moreover, when an anchor layer is provided, the pressure-sensitive-adhesive layer was transferred to the anchor layer surface of the polarizing film in which the anchor layer was formed.

### Examples 1 to 16, Comparative Examples 1 to 4, and Reference Examples 1 and 2

An anchor layer and a pressure-sensitive adhesive layer were sequentially formed by the combination shown in Table 1 on one side of the polarizing film obtained above, thereby to prepare a pressure-sensitive adhesive layer attached polarizing film. The anchor layer was used in each of Examples 15 and 16, and Comparative Example 3.

In Comparative Example 1, a polar functional group-containing monomer was not used as a monomer component that forms a pressure-sensitive adhesive layer, and in Comparative Examples 2 to 4, an organic cation-anion salt in place of the inorganic anion-cation salt was blended for preparing a pressure-sensitive adhesive composition.

The pressure-sensitive adhesive layers and the pressure-sensitive adhesive layer attached polarizing films obtained in the Examples and Comparative Examples were evaluated as follows. Evaluation results are shown in Table 2.

### <Surface Resistance Value (Ω/□): Conductivity>

(i) The surface resistance value of the anchor layer was measured on the anchor layer side surface of the anchor layer attached polarizing film before forming the pressure-sensitive adhesive layer.

(ii) The surface resistance value on a side of the pressure-sensitive adhesive layer was obtained by peeling the separator film from the obtained pressure-sensitive adhesive layer attached polarizing film and then measuring the surface resistance value on the surface of the pressure-sensitive adhesive layer (see Table 2).

The measurement was made using a device MCP-HT450 manufactured by Mitsubishi Chemical Analytech Co., Ltd. The surface resistance value (i) is a value after measurement for 10 seconds at an applied voltage of 10 V. The surface resistance value (ii) is a value after measurement for 10 seconds at an applied voltage of 250V

The ratio (b/a) of the variation in Table 2 is a value calculated from the surface resistance value (a) of “initial value” and the surface resistance value (b) of “after humidification” (a value rounded to one decimal place). In addition, as an index that is less likely to cause a decrease in the antistatic function or a decrease in the touch sensor sensitivity, the value with a smaller ratio of the variation was evaluated as being preferable based on the following criteria. In addition, the evaluation result which becomes a problem in practical use is indicated as x.

### (Evaluation Criteria)

⊙: The ratio of the variation exceeds 0.3 and is 2 or less.

∘: The ratio of the variation exceeds 0.1 and is 0.3 or less or exceeds 2 and is 5 or less.

x: The ratio of the variation is 0.1 or less or exceeds 5.

### <ESD Test>

In Examples 1 to 16 and Comparative Examples 1 to 4, a separator film was peeled off from the pressure-sensitive adhesive layer attached polarizing film and then the polarizing film was bonded to the viewing side of the in-cell type liquid crystal cell as shown in FIG. 3.

Next, a silver paste having a width of 10 mm was applied to the side surface portion of the bonded polarizing film so as to cover each side surface portion of the polarizing film and the pressure-sensitive adhesive layer and connected to a ground electrode from the outside. In addition, when an anchor layer is provided, the silver paste was coated so that each side surface portion of the polarizing film, the anchor layer, and the pressure-sensitive adhesive layer might be covered.

In Reference Examples 1 and 2, the separator film was peeled off from the pressure-sensitive adhesive layer attached polarizing film and then the polarizing film was bonded to the viewing side (sensor layer) of an on-cell liquid crystal cell.

The liquid crystal display device panel was set on a backlight device, and an electrostatic discharge gun was shot onto the polarizing film surface on the viewing side at an applied voltage of 9 kV, and the period until disappearance of white voids due to electricity was measured, and this was judged as “initial value” according to the following criteria. Regarding the value “after humidification”, as well as “initial value”, judgment was made according to the following criteria. The evaluation result causing a problem in practical use is indicated as x.

### (Evaluation Criteria)

⊙: The period until disappearance of white voids due to electricity is within 3 seconds.

∘: The period until disappearance of white voids due to electricity is more than 3 seconds and within 10 seconds.

Δ: The period until disappearance of white voids due to electricity is more than 10 seconds and within 60 seconds.

x: The period until disappearance of white voids due to electricity is more than 60 seconds.

### <TSP Sensitivity>

In Examples 1 to 16 and Comparative Examples 1 to 4, a lead wiring (not shown) at the peripheral portion of a transparent electrode pattern inside an in-cell type liquid crystal cell was connected to a controller IC (not shown), and in Reference Examples 1 and 2, a lead wiring at the peripheral portion of a transparent electrode pattern on an on-cell liquid crystal cell viewing side was connected to a controller IC, thereby to fabricate a liquid crystal display device with a built-in touch sensing function. In a state where the input display device of the liquid crystal display device with a built-in touch sensing function is used, visual observation was carried out and the presence or absence of malfunction was confirmed using this “initial value”. The presence or absence of malfunction was confirmed.

∘: No malfunction occurred

x: Malfunction occurred

### <Cloudiness Test Under Humidification>

The pressure-sensitive adhesive layer attached polarizing film obtained in each of Examples and Comparative Examples was cut into a size of 50 mm×50 mm, and after peeling off a separator film, the surface of the pressure-sensitive adhesive layer of the polarizing film was bonded to alkali glass (thickness: 1.1 mm, manufactured by Matsunami Glass Ind., Ltd.) and autoclaved at 50° C. for 15 minutes under a pressure of 5 atm to give a measurement sample for a cloudiness test. The measurement sample was placed in an environment of 60° C.×95% RH for 120 hours, then taken out at room temperature, and the haze value after 10 minutes was measured. The haze value was measured using a haze meter HM150 manufactured by Murakami Color Research Laboratory Co., Ltd. In addition, the evaluation result causing a problem in practical use is indicated as x.

### (Evaluation Criteria)

∘: The haze value is 5 or less, which is evaluated as good.

Δ: The haze value is more than 5 and less than 10, which is not a problematic level in practical use.

x: The haze value is 10 or more, which is a problematic level in practical use.

### <Adhesiveness (Anchoring Force)>

The produced antistatic pressure-sensitive adhesive polarizing plate was cut into a size of 25 mm width×50 mm length. The pressure-sensitive adhesive layer surface of this polarizing plate and the vapor deposition surface of the vapor deposited film formed by vapor deposition of indium-tin oxide on the surface of a polyethylene terephthalate film having a thickness of 50 μm were bonded together in contact with each other. Thereafter, the end portion of the polyethylene terephthalate film was manually peeled off to confirm that the pressure-sensitive adhesive was adhered to the polyethylene terephthalate film side. Then, the anchoring force (N/25 mm) between the polarizing film and the pressure-sensitive adhesive layer or between the anchor layer and the pressure-sensitive adhesive layer at a rate of 300 mm/min in the direction of 180° was measured under a room temperature environment (25° C.) using a tensile tester (Autograph AG-1 manufactured by Shimadzu Corporation).

The anchoring force is preferably 10 N/25 mm or more, more preferably 15 N/25 mm or more, and still more preferably 18 N/25 mm or more. If the anchoring force is less than 10 N/25 mm, adhesiveness is weak, and defects causing a problem may occur as follows: adhesive deficiency and adhesive staining may occur at the end portion when handling the pressure-sensitive adhesive layer attached polarizing film, or peeling may occur in a durability test, or peeling may occur when a liquid crystal display device is dropped.

### <Humidification Durability>

A pressure-sensitive adhesive layer attached polarizing film cut into a 15-inch size was used as a sample. The sample was stuck to a 0.7 mm-thick alkali-free glass (EG-XG, manufactured by Corning Incorporated) using a laminator.

Subsequently, the sample was autoclaved at 50° C. under a pressure of 0.5 MPa for 15 minutes to completely adhere to the alkali-free glass. The sample subjected to such treatment was treated for 500 hours in an atmosphere of 60° C./95% RH and then the appearance between the polarizing film and the alkali-free glass was visually evaluated according to the following criteria. In addition, the evaluation result causing a problem in practical use is indicated by x.

### (Evaluation Criteria)

∘: There is no change in appearance such as foaming and peeling, or slight peeling or foaming occurs at the end portion of the sample, causing no problem in practical use.

x: Significant peeling occurs at the end portion of the sample, causing a problem in practical use.

TABLE 1

| | | | | | | | Ionic compound | | |
|---|---|---|---|---|---|---|---|---|---|
| | | | | | | | | Blending | |
| | | | | | | | | amount | |
| | Composition of polymer (% by weight) | | | | | | | (parts by | Anchor |
| | BA | PEA | NVP | HBA | HEA | AA | Kind | weight) | layer |
| Example 1 | 99 | | | 1 | | | Li-TFSI | 0.3 | |
| Example 2 | 93.95 | | | | 0.05 | 6 | Li-TFSI | 0.3 | |
| Example 3 | 78 | 18 | 3.3 | 0.4 | | 0.3 | Li-TFSI | 0.3 | |
| Example 4 | 78 | 18 | 3.3 | 0.4 | | 0.3 | Li-TFSI | 1 | |
| Example 5 | 78 | 18 | 3.3 | 0.4 | | 0.3 | Li-TFSI | 10 | |
| Example 6 | 99 | | | 1 | | | Li-TFSI | 10 | |
| Example 7 | 93.95 | | | | 0.05 | 6 | Li-TFSI | 10 | |
| Example 8 | 99.9 | | | 0.1 | | | Li-TFSI | 10 | |
| Example 9 | 96 | | | 4 | | | Li-TFSI | 10 | |
| Example 10 | 99 | | | | 1 | | Li-TFSI | 10 | |
| Example 11 | 99 | | 1 | | | | Li-TFSI | 10 | |
| Example 12 | 99 | | | | | 1 | Li-TFSI | 10 | |
| Example 13 | 78 | 18 | 3.3 | 0.4 | | 0.3 | Li-FSI | 6.5 | |
| Example 14 | 69.3 | 18 | 12 | 0.4 | | 0.3 | Li-FSI | 6.5 | |
| Example 15 | 78 | 18 | 3.3 | 0.4 | | 0.3 | Li-TFSI | 0.3 | Yes |
| Example 16 | 99 | | | 1 | | | Li-TFSI | 0.3 | Yes |
| Comparative | 79 | 21 | | | | | Li-TFSI | 10 | |
| Example 1 | | | | | | | | | |
| Comparative | 93.95 | | | | 0.05 | 6 | MPP-TFSI | 10 | |
| Example 2 | | | | | | | | | |
| Comparative | 99 | | | 1 | | | EMI-TFSI | 0.3 | Yes |
| Example 3 | | | | | | | | | |
| Comparative | 93.95 | | | | 0.05 | 6 | MPP-TFSI | 20 | |
| Example 4 | | | | | | | | | |
| Reference | | | | | | | | | |
| Example 1 | 78 | 18 | 3.3 | 0.4 | | 0.3 | Li-TFSI | 10 | |
| Reference | 93.95 | | | | 0.05 | 6 | MPP-TFSI | 16 | |
| Example 2 | | | | | | | | | |

TABLE 2

| | Surface resistance | | | | | | | | | | | |
|---|---|---|---|---|---|---|---|---|---|---|---|---|
| | value of | | | | | | | | | | | |
| | pressure-sensitive | | | | | | | | | | | |
| | adhesive layer side | | | | | | | | | | | |
| | (Ω/□) | | | | TSP | | | | | | | |
| | | After | | | sensitivity | | ESD evaluation 9 kV | | | | | |
| | | humid- | | | | After | | | After | | | |
| | | ification | | | | humid- | | | humid- | | | |
| | | under | | | | ification | | | ification | | | |
| | | 60° C. × | | | | under | | | under | | | Cloud- |
| | | 95% RH | Ratio | | | 60° C. × | Kind of | | 60° C. × | Anchoring | | iness |
| | | for 250 | of | | | 95% RH | eval- | | 95% RH | force | Humid- | under |
| | Initial | hours | variation | | | for 250 | uation | | for 250 | (adhesiveness) | ification | humid- |
| | (a) | (b) | (b/a) | | Initial | hours | panel | Initial | hours | (N/25 mm) | durability | ification |
| Example 1 | 2.9E+11 | 2.6E+11 | 0.9 | ⊙ | ◯ | ◯ | In-cell | Δ | Δ | 20 | ◯ | ◯ |
| Example 2 | 4.4E+11 | 4.0E+11 | 0.9 | ⊙ | ◯ | ◯ | In-cell | Δ | Δ | 13 | ◯ | ◯ |
| Example 3 | 1.5E+11 | 1.7E+11 | 1.1 | ⊙ | ◯ | ◯ | In-cell | Δ | Δ | 22 | ◯ | ◯ |
| Example 4 | 3.9E+10 | 4.3E+10 | 1.1 | ⊙ | ◯ | ◯ | In-cell | Δ | Δ | 23 | ◯ | ◯ |
| Example 5 | 1.5E+09 | 1.7E+09 | 1.1 | ⊙ | ◯ | ◯ | In-cell | ◯ | ◯ | 15 | ◯ | Δ |
| Example 6 | 6.2E+08 | 3.1E+08 | 0.5 | ⊙ | ◯ | ◯ | In-cell | ⊙ | ⊙ | 20 | ◯ | Δ |
| Example 7 | 8.7E+08 | 7.0E+08 | 0.8 | ⊙ | ◯ | ◯ | In-cell | ⊙ | ⊙ | 13 | ◯ | Δ |
| Example 8 | 1.2E+09 | 2.4E+09 | 2.0 | ⊙ | ◯ | ◯ | In-cell | ◯ | ◯ | 18 | ◯ | Δ |
| Example 9 | 7.0E+08 | 2.8E+08 | 0.4 | ⊙ | ◯ | ◯ | In-cell | ⊙ | ⊙ | 14 | ◯ | Δ |
| Example 10 | 6.3E+08 | 3.2E+08 | 0.5 | ⊙ | ◯ | ◯ | In-cell | ⊙ | ⊙ | 21 | ◯ | Δ |
| Example 11 | 1.1E+09 | 2.1E+09 | 1.9 | ⊙ | ◯ | ◯ | In-cell | ◯ | ◯ | 16 | ◯ | Δ |
| Example 12 | 9.3E+08 | 1.6E+09 | 1.7 | ⊙ | ◯ | ◯ | In-cell | ⊙ | ◯ | 17 | ◯ | Δ |
| Example 13 | 1.1E+09 | 1.3E+09 | 1.2 | ⊙ | ◯ | ◯ | In-cell | ◯ | ◯ | 14 | ◯ | Δ |
| Example 14 | 5.6E+09 | 5.6E+09 | 1.0 | ⊙ | ◯ | ◯ | In-cell | ◯ | ◯ | 22 | ◯ | ◯ |
| Example 15 | 2.3E+09 | 4.4E+09 | 1.9 | ⊙ | ◯ | ◯ | In-cell | ⊙ | ⊙ | 22 | ◯ | ◯ |
| Example 16 | 1.2E+09 | 2.4E+09 | 2.0 | ⊙ | ◯ | ◯ | In-cell | ⊙ | ⊙ | 21 | ◯ | ◯ |
| Comparative | 4.3E+09 | 1.5E+10 | 3.6 | ◯ | ◯ | ◯ | In-cell | ◯ | Δ | 13 | ◯ | x |
| Example 1 | | | | | | | | | | | | |
| Comparative | 7.3E+08 | 9.5E+08 | 1.3 | ⊙ | ◯ | ◯ | In-cell | ⊙ | ⊙ | 8 | x | Δ |
| Example 2 | | | | | | | | | | | | |
| Comparative | 1.2E+09 | 2.9E+09 | 2.4 | ◯ | ◯ | ◯ | In-cell | ⊙ | ⊙ | 9 | x | ◯ |
| Example 3 | | | | | | | | | | | | |
| Comparative | 7.9E+07 | 1.0E+08 | 1.3 | ⊙ | x | ◯ | In-cell | ⊙ | ⊙ | 6 | x | Δ |
| Example 4 | | | | | | | | | | | | |
| Reference | 1.5E+09 | 1.7E+09 | 1.1 | ⊙ | x | x | On-cell | ⊙ | ⊙ | 14 | x | Δ |
| Example 1 | | | | | | | | | | | | |
| Reference | 4.1E+08 | 6.6E+08 | 1.6 | ⊙ | x | x | On-cell | ⊙ | ⊙ | 6 | x | Δ |
| Example 2 | | | | | | | | | | | | |

From the evaluation results of Table 2 above, in all the Examples, it was confirmed that cloudiness preventing property under humidification, adhesiveness, humidification durability, antistatic property, suppression of electrostatic unevenness, and touch sensor sensitivity were at practical levels. Further, the desired effects can be obtained also in Examples 15 and 16 in which not only the pressure-sensitive adhesive layer provided with the antistatic property but also the anchor layer having the antistatic property (conductivity) are provided. In particular, when the anchor layer having an antistatic property (conductivity) is provided, excellent effects could be confirmed.

On the other hand, in Comparative Example 1, since a polar functional group-containing monomer was not contained in the monomer component used in the pressure-sensitive adhesive layer, cloudiness of the pressure-sensitive adhesive layer in a humidified environment was confirmed.

Moreover, in Comparative Examples 2 to 4, since only an organic cation-anion salt instead of the inorganic cation-anion salt was blended as an antistatic agent used in the pressure-sensitive adhesive layer, it was confirmed that adhesiveness between the polarizing film or the anchor layer and the pressure-sensitive adhesive layer was deteriorated, and humidification durability was poor. Particularly, in Comparative Example 4, since the amount of the organic cation-anion salt used was large, it was confirmed that not only adhesiveness and humidification durability were reduced but also the surface resistance value was below the preferable range and the initial touch sensor sensitivity was poor. In Reference Examples 1 and 2, when the pressure-sensitive adhesive layer attached polarizing film was applied to an on-cell type liquid crystal cell, decrease in the touch sensor sensitivity was confirmed.

### DESCRIPTION OF REFERENCE SIGNS

A Pressure-sensitive adhesive layer attached polarizing film
B In-cell type liquid crystal cell
C In-cell type liquid crystal panel
1, 11 First and second polarizing films
2, 12 First and second pressure-sensitive adhesive layers
3 Anchor layer
4 Surface treatment layer
20 Liquid crystal layer
31 Touch sensor electrode
32 Touch driving electrode
33 Touch driving electrode and sensor electrode
41, 42 First and second transparent substrates

1. A pressure-sensitive adhesive layer attached polarizing film comprising a pressure-sensitive adhesive layer and a polarizing film, wherein:
the pressure-sensitive adhesive layer is formed from a pressure-sensitive adhesive composition containing an inorganic cation-anion salt and a (meth)acrylic polymer containing, as monomer units, an alkyl (meth)acrylate and a polar functional group-containing monomer; and
a ratio (b/a) of a variation in a surface resistance value on a side of the pressure-sensitive adhesive layer is 5 or less, provided that:
the “a” in the ratio b/a represents a surface resistance value on the side of the pressure-sensitive adhesive layer when peeling a separator immediately after producing the pressure-sensitive adhesive layer attached polarizing film in a state where the polarizing film is provided with the pressure-sensitive adhesive layer and the pressure-sensitive adhesive layer is provided with the separator; and
the “b” in the ratio b/a represents a surface resistance value on the side of the pressure-sensitive adhesive layer when peeling the separator after placing the pressure-sensitive adhesive layer attached polarizing film in a humidified environment of 60° C.-95% RH for 250 hours and further drying the pressure-sensitive adhesive layer attached polarizing film at 40° C. for 1 hour, respectively.

2. The pressure-sensitive adhesive layer attached polarizing film according to claim 1, wherein the inorganic cation-anion salt contains a fluorine-containing anion.

3. The pressure-sensitive adhesive layer attached polarizing film according to claim 1, wherein the surface resistance value on the side of the pressure-sensitive adhesive layer when peeling a separator immediately after producing the pressure-sensitive adhesive layer attached polarizing film in a state where the pressure-sensitive adhesive layer is provided with the separator is from 1.0×10⁸ to 1.0×10¹²Ω/□.

4. The pressure-sensitive adhesive layer attached polarizing film according to claim 1, wherein the polar functional group-containing monomer is a hydroxyl group-containing monomer.

5. The pressure-sensitive adhesive layer attached polarizing film according to claim 1, wherein an anchor layer is provided between the polarizing film and the pressure-sensitive adhesive layer, and the anchor layer includes a conductive polymer.

6. A pressure-sensitive adhesive layer attached polarizing film for an in-cell type liquid crystal panel, which comprises a liquid crystal cell including a liquid crystal layer containing liquid crystal molecules that are homogeneously aligned in the absence of an electric field, a first transparent substrate and a second transparent substrate sandwiching the liquid crystal layer on both sides, and a touch sensing electrode unit related to a touch sensor and touch-driven functions disposed between the first transparent substrate and the second transparent substrate, wherein:
the pressure-sensitive adhesive layer attached polarizing film is disposed on a viewing side of the in-cell type liquid crystal cell;
the pressure-sensitive adhesive layer of the pressure-sensitive adhesive layer attached polarizing film is disposed between the polarizing film of the pressure-sensitive adhesive layer attached polarizing film and the in-cell type liquid crystal cell;
the pressure-sensitive adhesive layer is formed from a pressure-sensitive adhesive composition containing an inorganic cation-anion salt and a (meth)acrylic polymer containing, as monomer units, an alkyl (meth)acrylate and a polar functional group-containing monomer; and
a ratio (b/a) of a variation in a surface resistance value on a side of the pressure-sensitive adhesive layer is 5 or less; provided that:
the “a” in the ratio b/a represents a surface resistance value on the side of the pressure-sensitive adhesive layer when peeling a separator immediately after producing the pressure-sensitive adhesive layer attached polarizing film in a state where the polarizing film is provided with the pressure-sensitive adhesive layer and the pressure-sensitive adhesive layer is provided with the separator; and
the “b” in the ratio b/a represents a surface resistance value on the side of the pressure-sensitive adhesive layer when peeling the separator after placing the pressure-sensitive adhesive layer attached polarizing film in a humidified environment of 60° C.×95% RH for 250 hours and further drying the pressure-sensitive adhesive layer attached polarizing film at 40° C. for 1 hour, respectively.

7. The pressure-sensitive adhesive layer attached polarizing film for an in-cell type liquid crystal panel according to claim 6, wherein the inorganic cation-anion salt contains a fluorine-containing anion.

8. The pressure-sensitive adhesive layer attached polarizing film for an in-cell type liquid crystal panel according to claim 6, wherein the surface resistance value on the side of the pressure-sensitive adhesive layer when peeling a separator immediately after producing the pressure-sensitive adhesive layer attached polarizing film in a state where the pressure-sensitive adhesive layer is provided with the separator is from 1.0×10³ to 1.0×10¹²Ω/□.

9. The pressure-sensitive adhesive layer attached polarizing film for an in-cell type liquid crystal panel according to claim 6, wherein the polar functional group-containing monomer is a hydroxyl group-containing monomer.

10. The pressure-sensitive adhesive layer attached polarizing film for an in-cell type liquid crystal panel according to claim 6, wherein an anchor layer is provided between the polarizing film and the pressure-sensitive adhesive layer, and the anchor layer includes a conductive polymer.

11. An in-cell type liquid crystal panel comprising:
an in-cell type liquid crystal cell which is provided with a liquid crystal layer comprising liquid crystal molecules that are homogeneously aligned in the absence of an electric field, a first transparent substrate and a second transparent substrate sandwiching the liquid crystal layer on both sides, and a touch sensing electrode unit related to a touch sensor and touch-driven functions between the first transparent substrate and the second transparent substrate; and
a first polarizing film disposed on a viewing side of the in-cell type liquid crystal cell, a second polarizing film disposed on an opposite side of the viewing side, and a first pressure-sensitive adhesive layer disposed between the first polarizing film and the in-cell type liquid crystal cell; wherein:
the first pressure-sensitive adhesive layer is formed from a pressure-sensitive adhesive composition comprising an inorganic cation-anion salt and a (meth)acrylic polymer containing, as monomer units, an alkyl (meth)acrylate and a polar functional group-containing monomer;
a ratio (b/a) of a variation in a surface resistance value on a side of the first pressure-sensitive adhesive layer is 5 or less, provided that:
the “a” in the ratio b/a represents a surface resistance value on the side of the first pressure-sensitive adhesive layer when peeling a separator immediately after producing the pressure-sensitive adhesive layer attached first polarizing film in a state where the first polarizing film is provided with the first pressure-sensitive adhesive layer and the first pressure-sensitive adhesive layer is provided with the separator; and
the “b” in the ratio b/a represents a surface resistance value on the side of the first pressure-sensitive adhesive layer when peeling the separator after placing the pressure-sensitive adhesive layer attached first polarizing film in a humidified environment of 60° C.×95% RH for 250 hours and further drying the pressure-sensitive adhesive layer attached first polarizing film at 40° C. for 1 hour, respectively.

12. The in-cell type liquid crystal panel according to claim 11, wherein the inorganic cation-anion salt contains a fluorine-containing anion.

13. The in-cell type liquid crystal panel according to claim 11, wherein the surface resistance value on the side of the first pressure-sensitive adhesive layer when peeling a separator immediately after producing the pressure-sensitive adhesive layer attached first polarizing film in a state where the first pressure-sensitive adhesive layer is provided with the separator is from 1.0×10⁸ to 1.0×10¹²Ω/□.

14. The in-cell type liquid crystal panel according to claim 11, wherein the polar functional group-containing monomer is a hydroxyl group-containing monomer.

15. The in-cell type liquid crystal panel according to claim 11, wherein an anchor layer is provided between the first polarizing film and the first pressure-sensitive adhesive layer, and the anchor layer includes a conductive polymer.

16. A liquid crystal display device comprising the in-cell type liquid crystal panel according to claim 11.
